(19) United States
(12) Patent Application Publication
(10) Pub. No.: US 2007/0251327 A1
(43) Pub. Date: Nov. 1, 2007

(54) Crash analysis through estimation of residual strains resulting from metal formation

(76) Inventor: William John Broene, Lowell, MI (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 11/403,367

(22) Filed: Apr. 13, 2006

(51) Int. Cl. G01B 7/16

(52) U.S. Cl. 73/769

(57) ABSTRACT

A method is disclosed for estimating or predicting residual strains resulting from metal formation. The method includes determining parameters indicative of physical and spatial characteristics of elements representing a formed metal part. A maximum plastic strain resulting from the metal forming processes is then estimated, as a function of the physical and spatial characteristics of a first one of the elements and a subset of the elements.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFISHE APPENDIX

Not applicable.

### BACKGROUND OF THE INVENTION

1. Field of the Invention

The invention relates to crash analysis and, more particularly, methods for estimating or predicting residual strains resulting from metal formation.

2. Background Art

For a substantial period of time, scientists and engineers have been interested in the causes of crashes, including those associated with automobiles, trains, airplanes and other vehicles and moving apparatus. Many of these studies in crash analysis are directed to human factors, including both physical and psychological considerations. Analysis of such factors as being impactive on airplane crashes have resulted in substantial modifications and redesigns over the years regarding pilot instrumentation panels. These redesigns have lowered the number of such crashes.

Other crash analysis has been directed to technological research involving the materials from which vehicles and other apparatus are constructed. For example, such research has been partially directed to selection of materials appropriate to “withstand” crashes. This research is not directed so much to reducing the number of crashes, but instead is directed to reducing the severity of damages and injuries resulting from the crashes.

Research related to crash analysis and material science may, for example, involve various testing procedures for the materials. As an example, many types of materials which form mechanical components of vehicles and other apparatus may be subject to rupture failures due to fatigue. In this regard, it is known that many types of mechanical components are subject to fatigue failures as a result of repeated loading and unloading. Accordingly, research in this area has been directed to measuring and testing fatigue properties of various samples of materials which may be subjected to repetitive and frequent loading. As apparent, it is impossible to employ testing methods for testing of real components, since components are often destroyed during testing.

Various advancements in crash analysis technology have evolved during the past few decades. These include research associated with non-destructive determination of fatigue and other properties in materials employed in vehicles and other apparatus. For example, a known laboratory technique for non-destructive measurement of fatigue limits employs cyclic tensile loading of material specimens, with the load being increased by steps. With each load value, relative dissipation energy is calculated. A point of inflection in the characteristic of energy dissipation is then plotted against load, and used to estimate an endurance limit. Although this technique may be characterized as correctly identifying a link between the phenomenon of a fatigue limit and the energy dissipation of material, it fails to present an operative method or apparatus for evaluating fatigue limits for real materials. For example, the tensile testing only yields required results for monocrystalline specimens. However, in standard polycrystalline materials, the complex response of the material under tensile stress will actually mask the point of inflection.

A further method is known for testing turbine blades for effects of overheating. This method includes the process of exciting bending vibrations in the blade under test, at its resonate frequency and two adjacent frequencies. A measure of internal friction is then calculated. A decrease of 10% from a previously measured value is considered to be indicative of deterioration due to overheating. A problem associated with this method is that an arbitrary fixed criterion for identifying deterioration is employed, without taking into consideration specific properties of materials involved. Also, the method fails to provide any quantitative information relating to a fatigue limit of the tested material. In addition, the use of bending vibrations preclude the application of the method to components of relatively complex shapes.

A further method for non-destructive determination of fatigue limits, and apparatus associated therewith, is disclosed in Azbel, U.S. Pat. No. 5,767,415 issued Jun. 16, 1998. The method actually includes two submethods, which may be performed separately or otherwise, in either order. Specifically, a measurement can be made of a micro-plastic deformation corresponding to each of a series of different known values of stress applied to the component under test. A critical value of stress can be identified, corresponding to a change in the relationship between stress and the micro-plastic deformation. The stress, in this case, will be torsional stress. Such stress can be characterized as that resulting from a twisting deformation of a solid body about an axis, in which lines initially parallel to the axis essentially become helices.

Further, in accordance with the Azbel method, the fatigue limit of interest is characterized as the flexural fatigue limit. The method includes a step of multiplying the critical value of stress by a torsional-to-flexural conversion coefficient. Still further, the method includes steps of applying the component under test to environmental conditions, likely to effect the fatigue limit during the measuring step. The environmental conditions can, for example, include exposure to an elevated temperature.

Still further, the Azbel method includes initiating torsional oscillations in the component, and measuring an initial angular amplitude of oscillation. The number of oscillations after measurement of the initial angular amplitude are then counted, and a final angular amplitude of oscillation is determined. The counting step and the measuring step for the final angular amplitude are then repeated a series of times for differing initial angular amplitudes. In this manner, pairs of measurements corresponding to the initial angular amplitude and final angular amplitude are determined, and a measure of damping corresponding to the initial angular amplitude is calculated for each measurement pair. A critical value is then identified for the initial angular amplitude corresponding to a change in the relationship between amplitude and damping. Azbel also describes various other and similar methods for deriving information relating to fracture toughness for components under test. For example, one of the methods includes the steps previously described herein, in addition to the calculation of at least one rate of change in the relationship between amplitude and damping. An identification is then made of first and second critical points corresponding to changes in the amplitude/damping relationship, with one of the change rates being calculated for measurements falling between the first and second critical points. Azbel further describes processing apparatus for performing the foregoing methods.

The concept of determining how various materials will react to different types of stresses is used in a number of applications independent of crash analysis. For example, it is known to measure line curvatures and compute stresses for components which may be formed on a substrate (e.g. a semiconductor or glass substrate) for use as integrated circuit devices. Suresh, et al., U.S. Pat. No. 6,600,565 issued Jul. 29, 2003 discloses the concept that for various types of integrated circuit devices, different materials and different structures may be formed on a substrate, and may be in contact with each other. With relatively complex multilayer geometry, interfacing of different materials and different structures may cause a relatively complex stress state in each component. This may result from differences in the material properties and the structure properties at interconnections under different fabrication processes and environmental factors (e.g. temperature fluctuations). Further, the stress state of interconnecting conducting lines in fabrication of an integrated circuit may be affected by film deposition, rapid thermal etching, chemical/mechanical polishing and passivation during fabrication.

Suresh, et al. further describe that it is advantageous to measure stresses on various components formed on the substrate, so as to improve device design, material selection and the fabrication process itself. Stress measurements may also be used to facilitate quality control of mechanical integrity and electromechanical functioning of circuit chip dies during large scale production and wafer fabrication facilities.

Suresh, et al. also describe the concept of employing a system having optical detection means for obtaining surface curvature information of a substrate-based device having line features formed on the substrate. Processing means are utilized so as to produce stress information of the line features based on curvature measurements. The optical detection means can include a coherent gradient sensing system, so as to measure the surface gradient of a surface based on phase information in the wavefront of a reflected optical probe beam.

More specifically, Suresh, et al. describe a method incorporating a measurement of a first curvature of a substrate at a location and along a longitudinal direction of a line feature formed at the location on the substrate. A second measurement of the substrate curvature is then taken at the same location, but along a transverse direction perpendicular to the longitudinal direction. Analytical functions are then used to compute stresses on the line feature, based on the first and second curvature measurements. In summary, a substantial portion of the Suresh, et al. patent is directed to identification of components such as defective computer chips. Components are measured by optical means, and curvatures are determined so that thermal elastic stresses can be determined. It should be noted that Suresh, et al. is not directed to determination of properties such as plastic strains and work hardening which may occur during metal part formation. Concepts associated with semiconductor wafers and various means for measuring surface curvatures are also disclosed in the following patents: Cheng, U.S. Pat. No. 5,227,641 issued Jul. 13, 1993; Borden, U.S. Pat. No. 5,966,019 issued Oct. 12, 1999; Rosakis, et al., U.S. Pat. No. 6,031,611 issued Feb. 29, 2000; and Suresh, et al., U.S. Pat. No. 6,513,389 issued Feb. 4, 2003.

As earlier stated, and as described in greater detail in subsequent paragraphs herein, crash analysis can involve studies of material forming and shaping processes. In metal forming, materials are typically plastically deformed between tools, so as to obtain a desired product. Prior to the use of digital technology, only a few analytical tools were available for purposes of determining parameters such as manufacturing feasibility. However, for a number of years, it has now been known to utilize computer based simulation software for simulating metal forming and shaping functions, so as to enable tool validation and machine designs for production, along with estimates of final work piece properties to be expected. That is, the manner in which the material is formed will often determine the “quality” and other features associated with the final product. In this regard, it is known to utilize “finite element analysis” ` processes for simulation of metal forming processes. The simulations can be utilized to determine shapes, residual stress distributions, resultant strain distributions and the like.

It is also known to employ computer simulations to generate various virtual prototypes of materials produced by metal forming. With respect specifically to crash analysis, it is known that crash analysis accuracy can be improved by including the effects of forming in material properties. That is, simulation processes exist so as to account for formed properties in crash analysis during both concept and detailed vehicle design stages. These concepts recognize the fact that the process of forming a component will change the properties of the material being used for the component. In the past, this has been somewhat ignored in the design and validation process of, for example, automotive structures. This has been true even though changes in material strength and thickness may be substantial. Today, finite element tools are available for purposes of determining as-formed material properties, and using the same in subsequent crash analysis simulations. In fact, not only have past activities directed to crash analysis involved forming effects on performance of individual components, but certain activities have also been directed to identifying consequences of including formed properties in full vehicle models.

With respect to the foregoing, one known method utilized with computer simulation for crash analysis for a vehicle body structure comprises three process steps and was developed by Corus Automotive. In this method, it is recognized that a vehicle body structure consists of hundreds of formed components. Accordingly, a detailed analysis of the stamping process can take a number of days per component part, for purposes of completion. The Corus method recognizes that certain components in the vehicle body structure are sensitive to forming, and also tends to recognize how the formed properties affect the vehicle crash performance. The first process step or first stage in the Corus method involves the identification of these key parts in which to include formed properties. In this regard, it is relatively important to understand that certain key factors may influence the behavior of crash structures, when considering what Corus characterizes as a “forming to crash” method. This method or procedure is characterized, for purposes of description, as the “F2C” procedure. The key factors may include material strength change, material thickness change and final geometric shape.

Material strength and thickness change may result from the straining of the material during the forming process. That is, forming introduces a residual strain in the material. “Residual” strain can be characterized as comprising a strain system within a solid, which is not dependent on external forces. The residual strain introduced by forming will essentially assist in “hardening” the material, thereby giving an effective increase in yield strength for subsequent deformations. That is, a forming strain will preferably provide an increase in yield strength, with the yield strength typically measured by MPa, where “Pa” is a pascal representing a unit of pressure equal to the pressure resulting from a force of one newton acting uniformly over an area of one square meter.

Material thickness change refers to the change in material thickness after forming. Stamping processes will typically decrease thickness from a starting thickness. Final geometric shape refers to the shape of the part after forming. The final shape can be influenced by properties such as elastic recovery of the material. Issues associated with geometric shape often occur with respect to high strength steels. For example, in forming section boxes with materials such as Dual Phase material, the boxes may exhibit side wall curl and spring back. This results from the high steel strength of the Dual Phase material and the residual stresses and strains introduced into the material during forming. Side wall curl and spring back can have the potential to influence collapse initiation of the section box. From previously undertaken tests, it has been determined in the prior art that the forming process significantly influences crash performance.

The second process step associated with the F2C procedure is to estimate the formed properties in the crash analysis. The approximate forming to crash analysis occurs at the vehicle concept stage. At this stage, estimates are made of the levels of change of performance from material changes introduced by the manufacturing processes. During this process step, and as an example, a part sketch may be utilized to estimate levels of equivalent plastic forming strain. By assuming a balanced bi-axial strain state, the thickness may be readily estimated, since the change in thickness is approximately proportional to the equivalent plastic strain. Accordingly, and as an example, a 10% strain would be assumed to give a 10% change in thickness. The influence of forming strains on the strength of the material can be included in the crash material models, by using approximately equivalent strains to “left shift” the material stress-strain curves.

The third process step of the Corus method includes procedures for predicting formed properties, using a full forming analysis. The formed properties are then mapped into the crash analysis model. This step then provides a detailed prediction of the strength levels and thickness of the material throughout the part, which are then used as inputs to the subsequent crash analysis. At this stage, it is necessary to have substantially accurate virtual prototypes for both crash and durability predictions.

To the extent that Corus has publicly disclosed processes and procedures associated with its three step process, it has taught the concept that including formed properties in vehicle body structure may have considerable influence on collapse modes of body components, particularly with respect to energy absorbed by surrounding components. The Corus method is further described, in public documents, as utilizing a selection procedure, in combination with processes associated with materials in forming, so as to provide an assessment of the sensitivity of a structure to formed properties. Detailed design is then characterized as being supported through the use of full forming simulation linked to major crash analysis codes.

With respect to the general teachings and the concepts associated with the Corus methods, it appears that the methods substantially rely on the experience of material and forming specialists providing what could be potentially “subjective” estimations. In this regard, such estimations can readily vary from one expert to the next, which can, in and of itself, render the methods inconsistent. Also, the known concepts associated with the Corus method appear to show that the method is not automated, therefore requiring additional time for processing. That is, it is believed that with use of the method, an “expert” essentially marks up sketches with estimates relating to the strain levels.

It is also believed that the assumption associated with Corus that the thickness strain is proportional to the equivalent plastic strain may not be valid for the case of bending. With a bending process, the top layer in the bending is in tension and the bottom layer compresses. Such action essentially results in relatively negligible change in thickness. However, bending accounts for a significant portion of operations which are typically used in forming a stamping. In any event, it appears that the Corus method teaches the concept that is worthwhile to conduct full forming analysis, and map the results of the analysis to crash models.

### SUMMARY OF THE INVENTION

In accordance with the invention, a method is provided for estimation and prediction of strains resulting from metal forming processes. The method is advantageous in that it can be used to estimate residual strains, without requiring the execution of forming simulations. A first-order crash analysis is utilized, with the process in accordance with the invention employing estimated residual strains, as opposed to known processes involving use of strains reported from several forming simulations. The invention is advantageous, in part, in that it increases the speed of the design process.

More specifically, the method includes the step of defining a geometric domain in which is represented the shape and configuration of a formed metal part. The geometric domain in then discretized into a number of elements representing the formed metal part. For each element, a set of parameters is determined. The parameters are indicative of physical characteristics and spatial characteristics of each element. For a first one of the elements, a maximum plastic strain is estimated, with the plastic strain resulting from the metal forming processes. The estimation is a function of the physical characteristics and the spatial characteristics of the first one of the elements, and a subset of the elements. Each element of the subset is a neighboring element of the first one of the elements.

Further in accordance with other aspects of the invention, each element can include a plate element. Further, the discretizing of the geometric domain can result in a mesh. Still further, the plate elements can include quadrilateral plate elements. The plate elements can also include triangular plate elements.

The method can further include the estimation of a plastic strain for each of the subset of elements. Further, the step of estimating the maximum plastic strain of the first one of the elements can be performed as a function of the estimates of plastic strains for each element of the subset of elements. Further, the step of estimating the maximum plastic strain of the first one of the elements can include a determination of a maximum of the estimates of plastic strains for each element of the subset of elements.

In accordance with another aspect of the invention, the physical characteristics can include thicknesses of each of the elements. The spatial characteristics can include angles between a normal vector of the first one of the elements, and normal vectors of each element of the subset of elements. Still further, the method in accordance with the invention can include defining each of the elements as having edges. The spatial characteristics can include mean distances between far element edges of the first one of the elements and each element of the subset of elements. Still further, the method can include the step of defining each of the elements as having nodes. Each of the nodes can be defined as having a specific location in three dimensional Cartesian coordinates.

The method for estimation and prediction can also include, for each element of the subset of elements, performance of the following function:

$${ɛ}_{i} = \vert ln ( 1 + \frac{T sin ϕ}{{l}_{e}} ) \vert$$

where εᵢ represents the calculated estimate of plastic strain for the element of the subset of the elements, T represents the thickness of the element of the subset, ø represents the angle between the normal vectors of the first one of the elements and the given subset element, and lₑ represents the mean distance between far element edges of the first one of the elements and the subset element. Still further, the maximum plastic strain estimate assigned to the first one of the elements can be determined by taking the maximum of the estimated plastic strains found for all elements of the subset of elements.

### BRIEF DESCRIPTION OF THE DRAWINGS

An illustrative embodiment of the invention will now be described with respect to the drawings, in which:

FIG. 1 is a diagrammatic representation of an LS-DYNA model which was created to analyze the forming process of a relatively simplistic metal part, using known guidelines for development of input parameters for metal forming simulations utilizing the LS-DYNA software;

FIG. 2 is a diagrammatic representation of a spring back model developed through a spring back simulation, again using the LS-DYNA software;

FIG. 3 is a diagrammatic representation of the LS-DYNA crash models developed through the execution of the simulations represented by FIGS. 1 and 2;

FIG. 4 is a graphical representation of the comparison of force versus displacement for both of the crash simulations illustrated in FIG. 3, with the solid line representing an “as rolled” configuration, while the phantom line represents the crash simulation incorporating residual stresses and strains;

FIG. 5 is a table illustrating error percentages which result when the forming stresses and strains are ignored (with the crash analysis using residual stresses and strains being assumed to be ideal).

FIG. 6 is a photograph of a drop tower test machine which was used in a physical realization to execute physical drop tower tests on two identical parts;

FIG. 7 is a photograph of a displacement sensor located within the drop tower test machine;

FIG. 8 is a photograph of a load sensor utilized within the drop tower test machine illustrated in FIG. 6;

FIG. 9 illustrates the placement of a specimen on a mounting plate of the test machine close fitted in FIG. 6;

FIG. 10 is a graph showing the load placed on the parts, with the FIG. 10 graph illustrating crushing force versus time, and with the FIG. 10 graph illustrating the load placed on the “as formed” part and the “heat treated” part;

FIG. 11 is a graph illustrating the comparison of energies absorbed by the specimen parts versus displacement, and as with FIG. 10, illustrating the displacement relationship with the “as formed” specimen part and the “heat treated” specimen part;

FIG. 12 is a graph illustrating the comparison of crushing forces exerted on the specimen parts, versus displacement, and again showing the graphical comparison for the “as formed” specimen part and the “heat treated” specimen part;

FIG. 13 is a table identifying percentages of discrepancy between the “as formed” specimen part and the “heat treated” specimen part, when crushed within the drop tower test machine;

FIG. 14 is a diagrammatic illustration of certain of the basic theoretical concepts behind strain estimations, and illustrates approximate fiber lengths after bending the specimen part to a 90° angle;

FIG. 15A is a graphical illustration of a manual application of a strain estimation method in accordance with the invention, illustrating the concept that material properties may be modified in the bend area of specimen parts, by offsetting the stress-strain curve by an estimated plastic strain; FIG. 15A can also be characterized as illustrating the shifting of the true-stress-true-effective-plastic-strain curve of a typical type of automotive stamping steel that has undergone strain during forming;

FIG. 15B is similar to FIG. 15A, but better represents the material behavior throughout the thickness, by defining a material that represents the average bending (forming) strain throughout the thickness;

FIG. 15C illustrates integration points through thickness locations for each element, where strain estimates can be provided;

FIG. 16 is a diagrammatic representation of an observation regarding the angle between neighboring segments, for purposes of obtaining estimated residual plastic strains from a forming process;

FIG. 17 is a further diagrammatic representation of neighboring segments and their lengths, as described in certain formulae set forth in the specification as disclosed in subsequent paragraphs herein;

FIG. 18 illustrates forming strain estimates written in LS-DYNA format *INITIAL_STRESS_SHELL cards;

FIG. 19 is a graphical representation showing a comparison of force versus displacement, for four different LS-DYNA crash models;

FIG. 20 is an illustration of a specimen part showing effective plastic strains at the top fiber, utilizing a forming simulation;

FIG. 21 is an illustration similar to FIG. 20, illustrating effective plastic strains at the top fiber of a specimen part, using estimation in accordance with the invention;

FIG. 22 is an illustration of a specimen part, showing a process involving a forming simulation for a steel bracket;

FIG. 23 is an illustration of a forming simulation of effective plastic strains at the top fiber of the specimen part illustrated in FIG. 22;

FIG. 24 is an illustration similar to FIG. 23, but illustrates the effective plastic strains at the top fiber of the steel bracket illustrated if FIG. 22, utilizing estimation in accordance with the invention;

FIG. 25 is a graphical representation of a comparison of the force versus displacement, for the steel bracket specimen part illustrated in FIG. 22, with the FIG. 25 graph illustrating comparisons for an “as rolled” process, forming strains simulation process and a process of estimating strains;

FIG. 26 is an illustration of the steel bracket specimen part shown in FIG. 22, as represented as a crash model;

FIG. 27 is a representation of an analysis input deck for the LS-DYNA software, for executing processes in accordance with the invention for estimation of residual strains brought about by forming metal; and

FIG. 28 is a functional sequence diagram showing method steps for estimation of residual strains in accordance with the invention.

### DESCRIPTION OF THE PREFERRED EMBODIMENTS

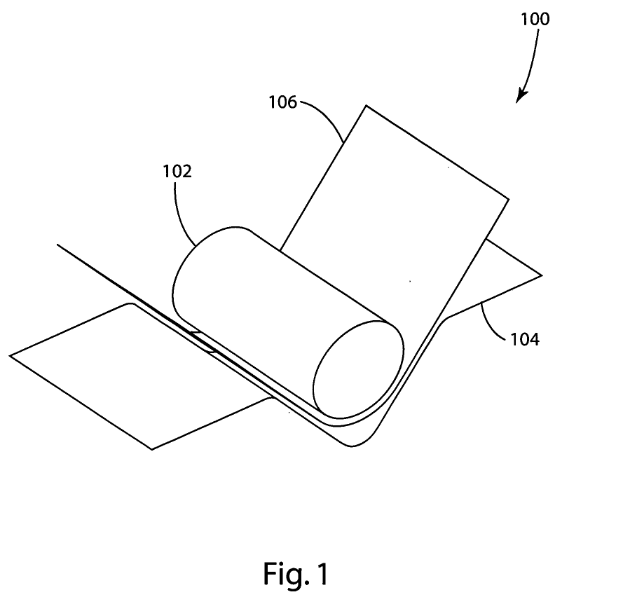

The principles of the invention are disclosed, by way of example, in a physically realized method for estimation of residual strains resulting from the forming of sheet metal. This method is described with respect to the illustrations and photographs set forth in FIGS. 1-28. As part of the description of an illustrative embodiment of the invention, results of use of the method in accordance with the invention are compared with determination of residual strains resulting from execution of metal forming simulations. As apparent from the subsequent description herein, and as applied to a first-order crash analysis, the use of estimated residual strains, rather than strains reported from several forming simulations, may increase the speed of the design process. As also set forth in subsequent paragraphs herein, test results are shown which were a physical realization of a comparison of a specimen part as formed, and an identical part which was heat treated for purposes of relieving at least some of the cold working strains.

Before discussing the illustrative embodiment of the method in accordance with the invention in detail, it may be worthwhile to briefly mention certain concepts associated with engineering mechanics and applicable to the pertinent technical arts encompassing the invention. More specifically, various types of metals, including sheet metal used in the production of automotive and other products, have been studied over a number of years to develop better metallic component parts for purposes of increasing survivability and otherwise limiting the often tragic and economic consequences of crashes. Technologies involving crash analysis have grown and developed from the desire of reducing the negative consequences of crashes. Accordingly, crash analysis has resulted in continuing research directed to ways of determining how a component part of a product will “act” in the event of a crash.

Of course, valuable information can be gained from creating an “actual” crash involving the component parts and the product itself. The negative consequences of requiring such actual crash tests are, however, obvious. To overcome the consequences of actual crash tests, advancements have been made in the technical arts directed to crash analysis through execution of crash simulations. Without going into substantial detail, since such detail is well known to those skilled in the pertinent arts, ongoing research and development continues in the area of attempting to improve the accuracy of crash analysis through simulations, by improving the accuracy of virtual prototypes.

In this regard, it has been found that the actual process of forming a product component will, in fact, change the properties of the material being used for the component. In the past, these property changes were often ignored in the design and validation process of products, such as automotive structures, even though changes in material strength and thickness could be substantial. Accordingly, relatively recent research and development has been directed to means for determining alterations of material properties of component parts during forming operations. Such alterations can then be used in subsequent simulations, including those directed to crash analysis. As described in subsequent paragraphs herein, methods in accordance with the invention are directed to processes for estimating strains brought about by metal formation, without requiring execution of metal forming simulations.

Although somewhat “simplistic,” it may also be worthwhile to briefly describe certain terminology associated with engineering mechanics involving metal forming. When forces are applied to various types of materials, including, for example, sheet metal, deformations will occur. In fact, the concept of metal “formation” refers specifically to physical alterations of the material part. In subsequent paragraphs herein, reference will be made, interchangeably, to material parts, product specimens, component parts and the like. With respect to changes of shape resulting from externally applied forces, the term “deformation” is typically used. Deformation of sheet metal can result from tensile forces (meaning “pulling”), compressive forces (meaning “pushing”), shear forces, and bending forces or torsion (i.e. twisting).

Depending upon particular materials utilized, sizes, geometry and applied forces, various types of deformation may result. For example, the term “elastic” deformation is often used to refer to deformation resulting from applied forces (referred to herein as “stress forces”). Elastic deformation is often also referred to as being “reversible,” in that once the external forces are no longer applied, the object part will return substantially to its original shape. Certain materials have relatively large elastic deformation ranges, while other materials undergo almost no elastic deformation in response to applied forces. Sheet metal can be referred to as having relatively moderate elastic deformation ranges. It may also be noted at this time that one type of phenomenon which is associated with elastic deformation is commonly referred to as “metal fatigue.” Metal fatigue typically will occur in ductile metals, and will occur even if the metal is typically subjected only to elastic deformation. In this regard, it was originally thought that a material deformed only within its elastic deformation range always returned completely to its original state, once the external forces were removed. However, faults actually are introduced at the molecular level, with each deformation. After a substantial number of deformations, cracks may begin to appear, followed by an actual fracture. Metal fatigue was a serious problem when commercial jet aircraft were first being developed during the 1950's.

Another type of deformation is referred to as “plastic” deformation. Plastic deformation is typically not reversible. An object part which has been subjected to sufficient external stresses so as to be within its plastic deformation range will first have undergone elastic deformation. Accordingly, an object part in the plastic deformation range may return at least part way to its original shape. Certain products have a relatively large plastic deformation range, including certain ductile metals. When a product part has reached the “end” of its plastic deformation range, a further deformation or “fracture” will occur. Clearly, fractures are not reversible.

More specifically, the term “plasticity” is also often used, to represent the property of a material to undergo shape changes in response to applied forces. Plastic deformation will typically occur under shear stress, as opposed to brittle fractures which will typically occur under normal stress. In this regard, for many ductile metals, tensile loading which may be applied to an object part will first cause the part to behave in an elastic manner. When in the elastic region, typically each load increment will be accompanied by a relatively proportional extension, and the object part will return substantially to its original size. However, when the load exceeds a threshold (often referred to as the “yield strength”), the extension will increase more rapidly than in the elastic region. When the load is removed, at least a certain portion of the extension will remain. This concept is relatively well known in engineering mechanics as “Hook's law.” In early research, it was found that ductile materials could sustain relatively large plastic deformations, without fracture. However, even ductile metals will fracture when strain becomes sufficiently large. Heat treatments, such as annealing, can restore ductility of a worked piece.

Other terms used herein include the term “residual stress.” Residual stress, also often referred to as “internal stress,” refers to a stress system within a solid which is independent of external forces. Correspondingly, the term “strain” can be characterized as meaning the change in length of an object part in some direction, per unit undistorted length in a particular direction, with the directions not necessarily being the same. Reference will also be made herein to “heat-treated” metal. This treatment, also often referred to as annealing, refers to subjecting, for example, metal, to alternate heating and cooling so as to produce certain desired characteristics, such as increased hardness. Reference is also made to the term “spring back,” meaning the resilience of the metal part recovering from its former state by elasticity.

Reference will now be made to physical experiments illustrating the general concept that inclusion of the effects of strains which result from forming of sheet metal are relatively important in crash analysis. For purposes of analyzing the forming process of a relatively simple part (which could be a part of an automobile, truck or other type of vehicle or product where crash analysis is applicable), an LS-DYNA model has been created. The part model is shown as forming model 100 as illustrated in FIG. 1. In FIG. 1, the component identified as component 102 and the component identified as component 104 represent tooling utilized to form the work piece identified as work piece 106. The tooling 102, 104 is restricted to move only in the “up/down” direction, while the work piece 106 is not restricted in any direction.

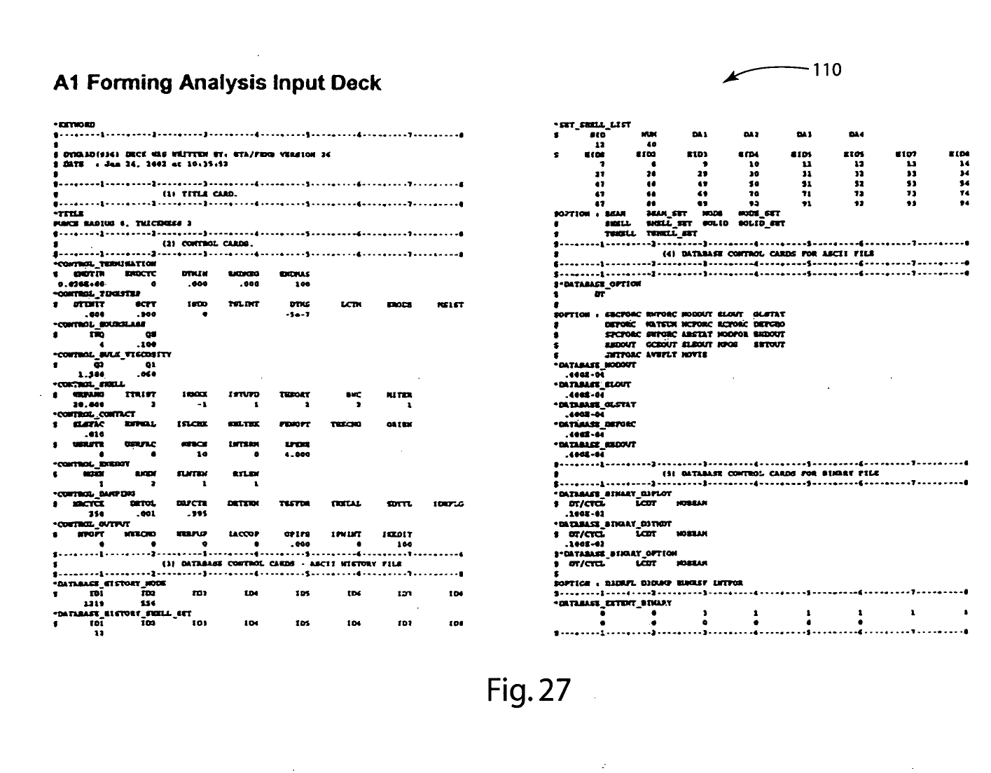

The forming model 100 was created using the LS-DYNA software. This software comprises a general purpose transient dynamic finite element program, capable of simulating complex real world problems. The software can be optimized for shared and distributed memory. The LS-DYNA programs were originally developed and are owned by Livermore Software Technology Corporation. The LS-DYNA programs have been often used to study automotive crashes. Procedures are relatively well known for conducting metal forming simulations using the LS-DYNA programs. When undertaking crash simulation procedures, it is known to utilize certain default input parameters. Correspondingly, it is also known to utilize somewhat different parameters for executing metal forming simulations. To create the forming model 100 for metal forming simulations, known guidelines were followed, with the guidelines being set forth in a document entitled Input Parameters for Metal Forming Simulation Using LS-DYNA, Bradley N. Maker. This document will be referred to herein as the “Maker Document.” With use of the guidelines in the Maker Document, an LS-DYNA input deck was created. The input deck is shown in FIG. 27, illustrated as input deck 110.

The program instructions and mnemonics as illustrated in input deck 110 will be recognizable to persons of ordinary skill in crash analysis technologies, having general knowledge of LS-DYNA software. The aforereferenced Maker Document generally describes the “best practices” to employ for assimilating a sheet metal forming process. The LS-DYNA software has built-in default parameters that are geared for crash analysis, as opposed to forming simulation. The Maker Document specifically recommends parameters to use for metal forming as a starting point. Further modifications can be made by a user, based on experience. Such modifications can involve parameters such as, for example, friction values, which may vary depending upon die lubricant supplier and other factors. Some of the best practices described in the Maker Document include the following: guidelines for modeling the tooling to work piece interface (contact); mass scaling (a method of reducing computation time); methods to automate the refining of the work piece mesh; means for activating material thinning calculations; means for defining draw beads (i.e. tooling elements that are designed to pull on work pieces, so as to eliminate wrinkling or encourage stretching); recommended plate element types; and how to define blank (work piece) holder forces and tooling motion.

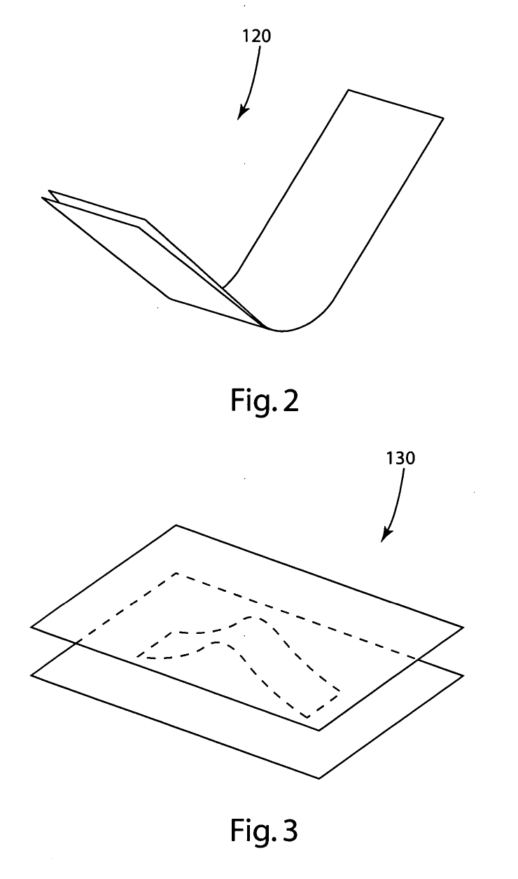

With respect to the specific LS-DYNA software used with the forming simulation, the key word “INTERFACE_SPRINGBACK” was utilized. This was to ensure that residual stresses and strains from the forming simulation analysis were loaded into a Dynain file. This file is then utilized within an LS-DYNA run which “models” or simulates spring back. In the past, the LS-DYNA software has been applied to spring back simulation, and is well-known in the prior art. Some of these simulations have had generally mixed results. An advancement in reducing the number of inconsistent results has been achieved through generation of input parameters for spring back simulation under a procedure described in a document entitled Input Parameters for Springback Simulation using LS-DYNA, by Bradley N. Maker and Xinhai Zhu, Livermore Software Technology Corporation, June 2001. A diagrammatic representation of the spring back model for simulation is identified as model 120 illustrated in FIG. 2. It should be noted that results from the forming simulation (shown in FIG. 1 as forming model 100) provide a starting point for the spring back simulation. That is, accuracy in the spring back simulation is dependent upon accuracy of the forming simulation. For use of the Dynain file method, the LS-DYNA software can be written so as to output a keyword-formatted file identified as “Dynain” at the end of the forming simulation, containing deformed mesh, stress and strain states. This Dynain file can then be utilized to form the spring back simulation as a follow up simulation. More specific detail regarding determination of input parameters for the spring back simulation are set forth in the Maker and Zhu document related to input parameters for spring back simulation. As with the forming simulation, the INTERFACE_SPRINGBACK keyword was utilized, so that residual stresses and strains could be used in the crash simulation itself.

With the forming and spring back simulations, comparison of methods in accordance with the invention relative to forming simulations then involved the development of two LS-DYNA crash models. The two crash models are illustrated in diagrammatic format in FIG. 3 as crash models 130. One of the models illustrated in FIG. 3 utilized the “INITIAL_STRESS_SHELL” cards from the Dynain file obtained from the spring back analysis. Correspondingly, the other of the crash models 130 illustrated in FIG. 3 did not use these cards, and thus this other one of the models 130 did not take into account residual stresses and strains from the spring back simulation. Accordingly, executing simulations employing the two crash models 130 provided for comparison of crash analysis results with and without the consideration of “cold work” from a forming process.

More specifically, the forming analysis results in the Dynain file, which contains node positions and *INITIAL_STRESS_SHELL cards. These node positions and *INITIAL_STRESS_SHELL cards are used as input to a spring back simulation. The spring back simulation results in another Dynain file, with this further Dynain file containing new node positions and *INITIAL_STRESS_SHELL cards. These node positions and *INITIAL_STRESS_SHELL cards are used as input to one crash simulation, while only the node positions are used as input to another crash simulation. More specifically, one simulation accounts for cold working, while the other simulation does not, because the *INITIAL_STRESS_SHELL cards are not used.

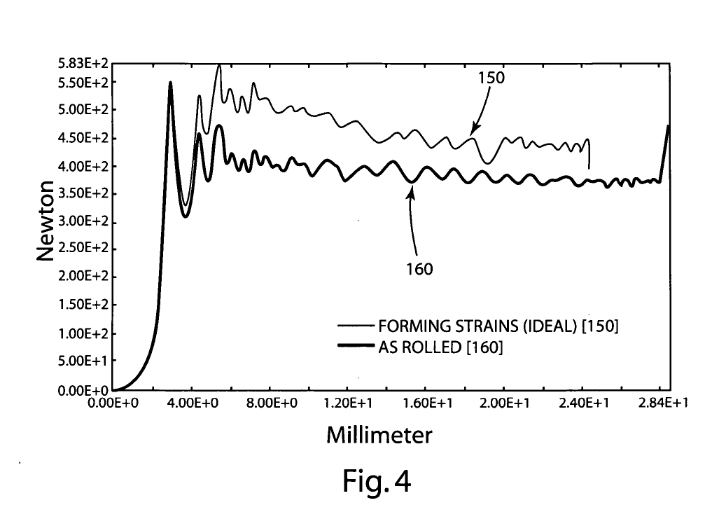

A physical realization of the crash simulations employing the crash models 130 illustrated in FIG. 3 is represented by the graph 140 set forth in FIG. 4. The graph 140 is a two-dimensional representation showing the relationship between applied forces and displacement for both of the crash simulations. Applied forces are illustrated in FIG. 4 as Newtons, while displacement is illustrated in millimeters. More specifically, the “force versus displacement” curve for the crash model 130 taking into account residual stresses and strains is shown by the phantom curve 150 of the graph 140. Correspondingly, the comparison of force versus displacement for the “as rolled” crash model is illustrated by the solid curve 160 in the graph 140 of FIG. 4.

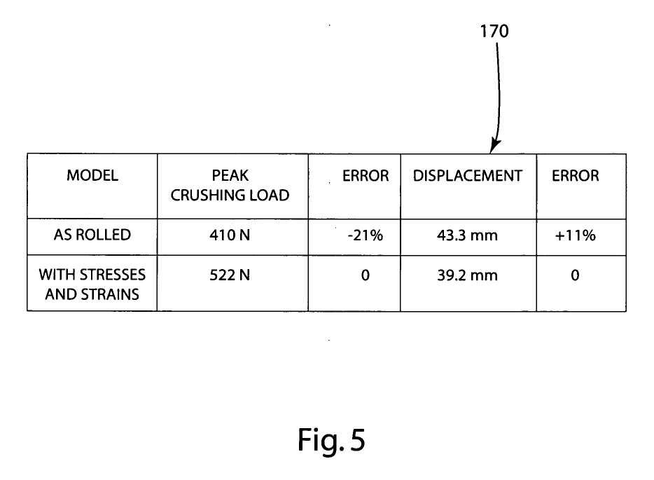

With the comparison of force versus displacement completed for both crash models, as illustrated in FIG. 4, a determination can be made as to error percentages resulting from the absence of consideration of the residual stresses and strains. Table 170 set forth in FIG. 5 identifies these error percentages. It should be noted that table 170 in FIG. 5 also refers to “peak crushing loads” and displacement, as well as error percentages. The peak crushing load can be characterized as the maximum load prior to when the tooling essentially “bottoms.” That is, when the punch bottoms out, the load may be somewhat higher than the peak crushing load. However, the peak crushing load is a better measurement for determining viability of these processes. Also, it should be explained at this time that “as-rolled” material properties are those properties taken directly from tensile test results from the metal coil. Correspondingly, “as formed” material properties are those properties taken from the formed part. Also, it should be understood that residual stresses and strains occur in bending, when the outer fiber has plastically deformed, while the inner fiber has only deformed elastically. The inner fibers “seek” their initial shape, but are resisted by the outer, permanently deformed fibers. It should be noted that the specific crash simulation using the crash model 130, which takes into account residual stresses and strains, is assumed to be “ideal.” That is, it is assumed that the determination of peak crushing load and displacement, through use of the crash simulation using the crash model 130 which takes into account residual stresses and strains, has zero error. With this assumption, table 170 shows that the crash analysis for the “as rolled” crash model (which ignores residual stresses and strains from the forming operation) indicates a −21.0 % error for peak crushing load and +11 %error for displacement. It is believed that table 170 is indicative of the importance of including forming stresses and strains in crash analysis procedures.

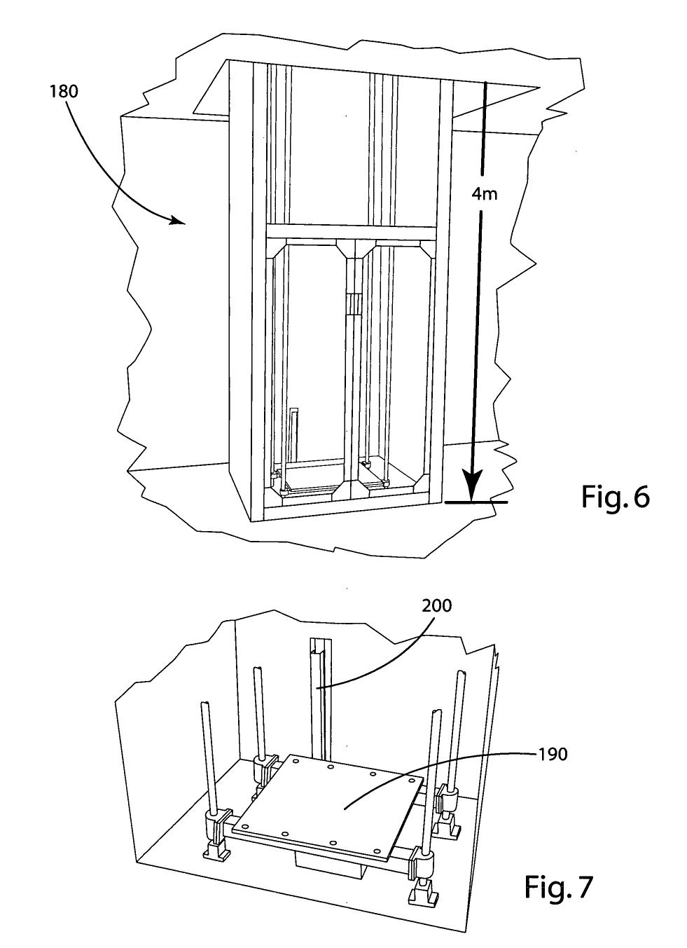

Equipment associated with a physical test of two identical parts will now be described, primarily with respect to FIGS. 6-13. In this regard, a drop tower test machine was utilized to perform physical drop tower tests on two identical parts. An exemplary drop tower test machine is shown in the photograph of FIG. 6, and is identified as drop tower test machine 180. The particular drop tower test machine illustrated in FIG. 6 was actually constructed for the assignee of the invention by students from Grand Valley State University, Allendale, Mich. However, concepts behind drop tower test machines are well known to those of ordinary skill in the technical arts to which the invention pertains. Any of a number of different designs for drop tower test machines could be utilized to perform experiments indicative of the importance of the invention.

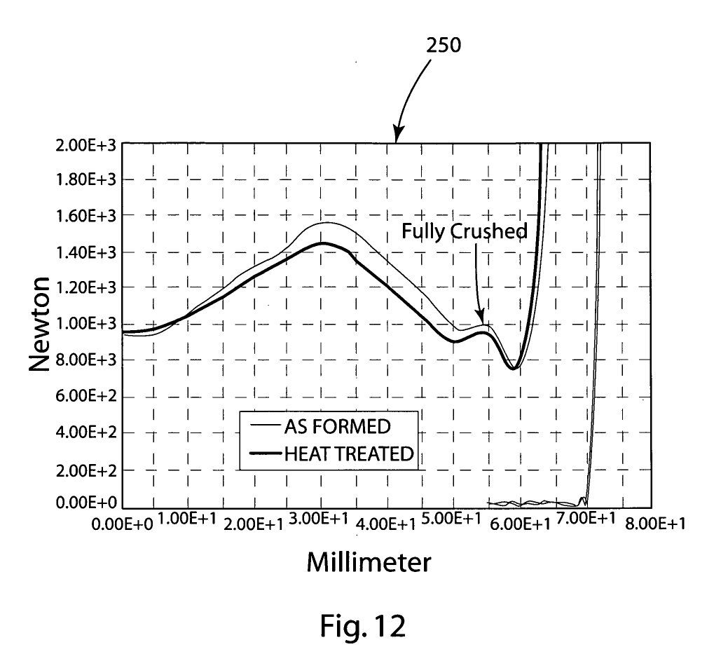

The purpose of the drop tower test machine 180 is to essentially “crush” parts, while measuring the crushing forces and crushing displacement. A “force versus displacement” curve is then plotted (see FIG. 12), where the crushing force is illustrated on the y axis, while the crushing displacement is along the x axis. This curve is then integrated, so as to determine the amount of crushing energy capable of being absorbed by the part.

In the particular drop tower test machine 180, the test machine employed a “ram” which was raised and then allowed to “free-fall” along guide rails forming a vertical axis. Drop height can be varied, and set so as to achieve a desired impact velocity and kinetic energy. In the particular drop tower test machine 180, the ram was raised to the desired drop height, through the utilization of a cable and pulley. The part to be crushed in the test machine 180 can be positioned on a mounting plate, with the mounting plate free to move along the vertical axis.

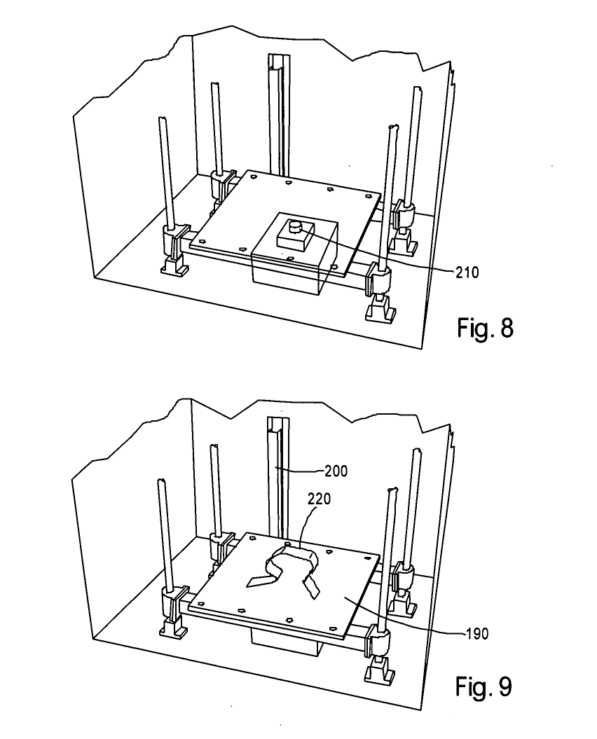

In this regard, FIG. 7 illustrates the interior of the drop tower test machine 180, and also illustrates a mounting plate 190. The specimen part to be tested is positioned on the mounting plate 190 during tests. FIG. 9 illustrates the placement of a specimen part 220 on the mounting plate 190, within the interior of the test machine. Just underneath the mounting plate 190 within the interior of the test machine is a “button type” load cell or load sensor. FIG. 8 comprises a photograph of part of the interior of the test machine 180, showing the location of a load sensor 210 therewithin. Load sensor 210 can be any of a number of different commercially available sensors. For example, load sensor 210 may be one manufactured by Measurement Specialists, Inc. and identified as Model Number 1211. This load cell or load sensor 210 is wired to a signal amplifier and conditioner, so as to provide an analog voltage signal. In the particular embodiment of the testing which was undertaken by the assignee of the invention, the analog voltage signal was applied to a DAS8 Keithley Metrabite data acquisition board installed in a computer. Conventional software also installed in the computer converted the digital voltage data into appropriate force units. When the force signal reaches a predefined threshold value, storage of the force and displacement data can be initiated. In the particular experiments undertaken by the assignee of the invention, the threshold value was approximately 1000 Newtons. Using the threshold value ensured that captured data comprised data being generated while the part was being crushed, and not prior to the crushing action when the ram was in a “free-fall” state.

In addition to the foregoing, a displacement sensor was also mounted within the interior of the test machine 180. Such a displacement sensor is illustrated as displacement sensor 200 in FIG. 7. In the particular experimentation undertaken by the assignee of the invention, the displacement sensor 200 corresponded to one manufactured by Balluff, Inc., with a Model Number BTL-5-B11-M0305-P-S32. The displacement sensor 200, as illustrated in FIG. 7, is mounted stationary and adjacent to the part to be tested. The displacement sensor 200 is orientated along the vertical axis. A magnet is mounted on the ram. When the ram falls to within 305 millimeters of the mounting plate 190, the displacement sensor will sense the existence of the magnet, and therefore send a signal of less than +5 volts to the DAS8 data acquisition board. With the particular experimentation undertaken by the assignee of the invention, signals of +5 or more volts corresponded to the magnet being out of the sensing range. Storage of data from the displacement sensor would be initiated when the load cell reached a threshold value, i.e. when the ram actually contacted the part to be tested. It should also be noted that in the particular experiments undertaken by the assignee of the invention, the height of the drop tower test machine 180 was approximately 4 meters. With the use of the drop tower test machine 180, and the components previously described herein, two identical specimen parts 220 were tested. However, prior to testing, one part 220 subjected to test was first heat treated for eight hours, at 800° F. Following the heat treatment, the specimen part 220 was then air-cooled, so as to relieve some of the strains resulting from forming. The other specimen part 220, although identical to the heat treated specimen part 220, was subjected to the crushing test without any type of treatment following the forming process.

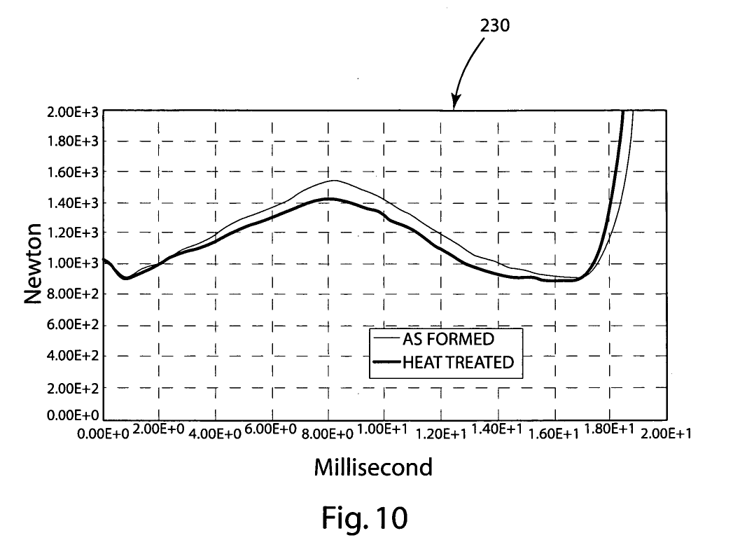

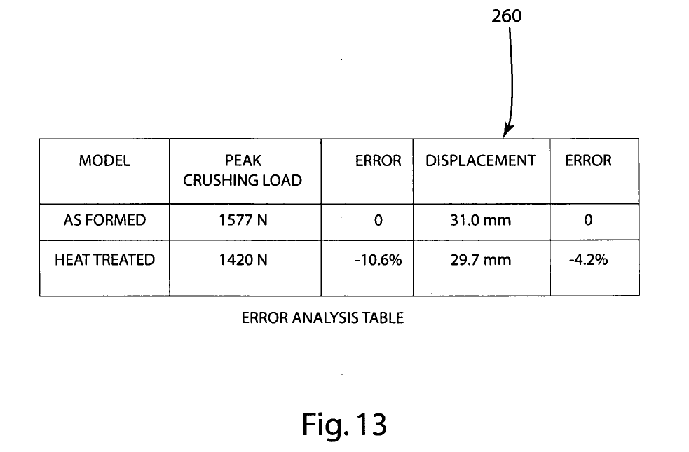

The results of the physical drop tower tests are illustrated in the graphs of FIGS. 10,11 and 12, and the table of FIG. 13. More specifically, FIG. 10 illustrates the application of load in Newtons over time. The “+” graph line represents the specimen part which was not subjected to any treatment after forming. The “boxed” graph line illustrates the performance of the specimen part which was heat treated and then air cooled after forming. Again, the heat treatment, in combination with the air cooling, was utilized to relieve some of the residual strains which may have resulted from the forming process.

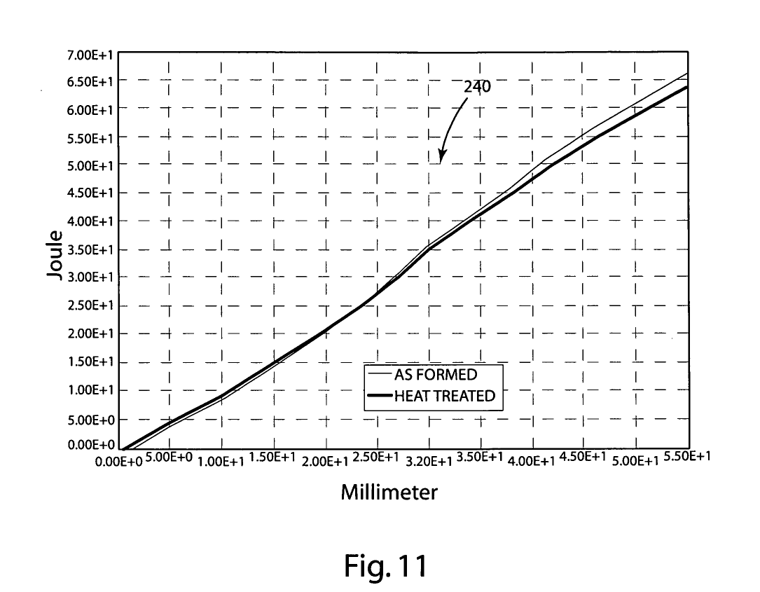

FIG. 11 illustrates the absorption of energy of the two specimen parts, over displacement during the physical load test. FIG. 10 illustrates time in milliseconds. The “+” graph line in FIG. 11 represents the energy absorbed (in Joules) versus displacement for the specimen part which was not subjected to any treatment after forming. The “boxed” graph line represents the energy absorbed versus displacement for the specimen part which, in fact, was subjected to heat treatment and then air cooling following the forming process.

FIG. 12 is a graph somewhat similar to the graph of FIGS. 10 and 11 but illustrating the crushing forces applied to the specimen parts as a function of displacement. As with FIGS. 10 and 11, the “+” line represents the application of crushing forces (in Newtons) as a function of displacement (in millimeters) for the specimen part which was not subjected to treatment following the forming process. The “boxed” graph line represents the application of crushing forces as a function of displacement for the specimen part subjected to heat treatment and air cooling following the forming process. With respect to the function of the drop tower test machine 180, and with reference to FIG. 12, shortly after the ram of the drop tower test machine 180 makes contact with the specimen part 220, the threshold load value of approximately 1000 Newtons is reached, and the capturing of data is initiated. The first 30 millimeters of “crush” involve elastic deformation, where the part is essentially acting like a spring. Once full yielding occurs at 30 millimeters of crush, the specimen part 220 plastically deforms, until the part essentially folds into itself and simply compresses. The arrow illustrated in FIG. 12 shows the state of the crushing process when the specimen parts 220 are in this fully crushed state. At this point, the load on the specimen parts 220 may or may not increase, depending upon the initial kinetic energy and the energy absorbed by the specimen parts. In the cases shown in FIG. 12, there was sufficient energy left over after the crushing process, which caused an elastic compression and subsequent decompression of approximately 15 millimeters, as further illustrated in FIG. 12.

The results of the physical tests as illustrated in the graphs of FIGS. 10, 11 and 12 are summarized in the table of FIG. 13. More specifically, the FIG. 13 table identifies the percentages of discrepancy between the heat treated specimen part and the non-heat treated specimen part, which respect to the crushing forces corresponding to the peak crushing load, and the displacement of each of the specimen parts at the peak crushing load. As earlier referenced, the peak crushing load can be characterized as the maximum load which occurs as the specimen part crushes, before the tooling essentially “bottoms out.” The specimen part which was not subjected to heat treatment is characterized as having a “delta” of zero, with respect to the peak crushing load and the displacement at the peak crushing load. As also illustrated in FIG. 13, the peak crushing load of the non-heat treated specimen part occurred at 1577 Newtons. The displacement at the peak crushing load for this specimen part was 31.0 millimeters. In contrast, and as shown in FIG. 13, the peak crushing load for the heat treated specimen part occurred at 1420 Newtons. The difference of the peak crushing loads for the two specimen parts shows a delta or “discrepancy” for the heat treated specimen part of −10.6%. Correspondingly, the displacement at the peak crushing load of the heat treated specimen part, as also shown in FIG. 13, was 29.7 millimeters. This displacement, compared to the displacement of the non-heat treated specimen part, represented a delta or discrepancy of −4.2%.

From these physical tests, and the subsequent analysis thereof, it is unknown whether or not all of the strain hardening from the forming process was actually removed by subjecting the one specimen part to heat treatment. However, it is believed that the physical tests carried out in a physically realizable environment are indicative of the fact that there is a difference in “crushing performance,” based on the amount of strain hardening in a formed part.

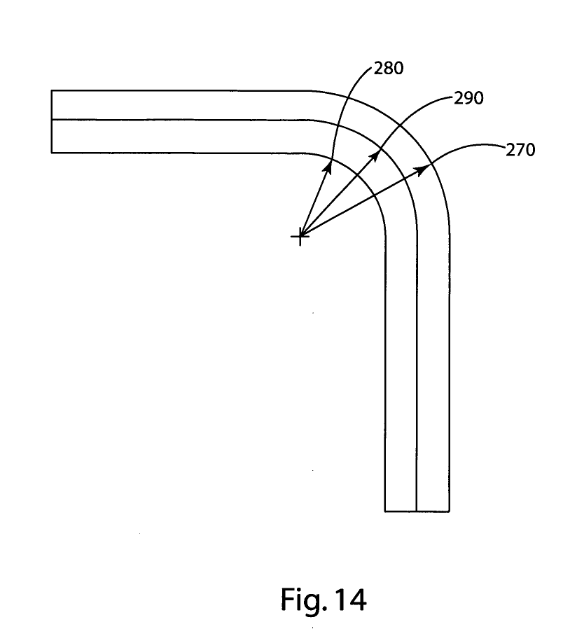

The foregoing disclosure generally described concepts associated with the relative importance of including forming strains in crash analysis. These concepts were illustrated, in part, using the forming model 100, spring back simulation model 120 and crash models 130 as shown in the illustrations of FIGS. 1, 2 and 3, respectively. Comparisons of force versus displacement curves and error percentages were shown in the graph 140 of FIG. 4 and the table 170 of FIG. 5. Physically realized drop tests were then described with respect to use of the physical drop tower test machine 180 and components thereof, as illustrated in FIGS. 6-9. Graphs 230, 240 and 250, illustrating crushing forces and energy absorbed versus time, and crushing forces versus displacement were then illustrated in FIGS. 10, 11 and 12, respectively. Table 260 of FIG. 13 was referenced, with the table 260 describing discrepancy percentages between heat treated and non-heat treated specimen parts, when crushed in the drop tower test machine 180. All of the foregoing related to the use of forming simulations. General theories associated with strain estimation, and how the same is utilized in accordance with the invention, will now be described. To illustrate the strain estimation theories, FIG. 14 illustrates changes in length of an outer fiber 270 and an inner fiber 280, following a 90° bending operation. The fibers 270, 280 as shown in FIG. 14 are assumed to have an initial length of 15.708 millimeters, prior to being subjected to bending at a 90° angle. The fibers are further assumed to be bent at the 90° over an 8 millimeter radius die. Following the bending operation, the fiber lengths can be characterized by the following equation:
l_{f}=r_{f}θ Equation 3

Where θ is the bend angle, measured in radians, and r_{f} is the radius of the fiber. l_{f} is the fiber length for that particular fiber f.

For each fiber, an average plastic strain ε_{f} is then determined. Each average plastic strain ε_{f} along each fiber f is estimated by the following equation:

$${ɛ}_{f} = \frac{{r}_{f} θ - {l}_{m}}{{l}_{m}} \qquad Equation 4$$

Where lₘ is the approximate length of the middle fiber. Given that lₘ can be characterized in terms of radii and angles by the equation “rₘθ” (where rₘ is the radius of the middle fiber), Equation 4 can then be written all in terms of radii and angles, in accordance with the following:

$${ɛ}_{f} = \frac{{r}_{f} θ - {r}_{m} θ}{{r}_{m} θ} \qquad Equation 5$$

The angles can then be “canceled out,” and the estimated strain ε can then be expressed in terms of the middle radius rₘ and the metal thickness t. This estimation ε can then be written as follows:

$$ɛ = \pm \frac{t}{2 {r}_{m}} \qquad Equation 6$$

Where t is the thickness of the formed part, and rₘ is the mid-surface radius of the part.

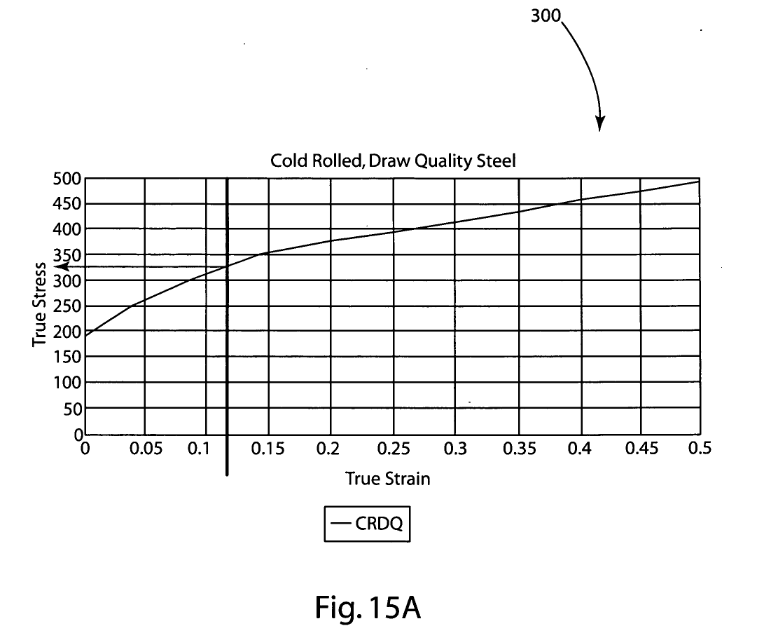

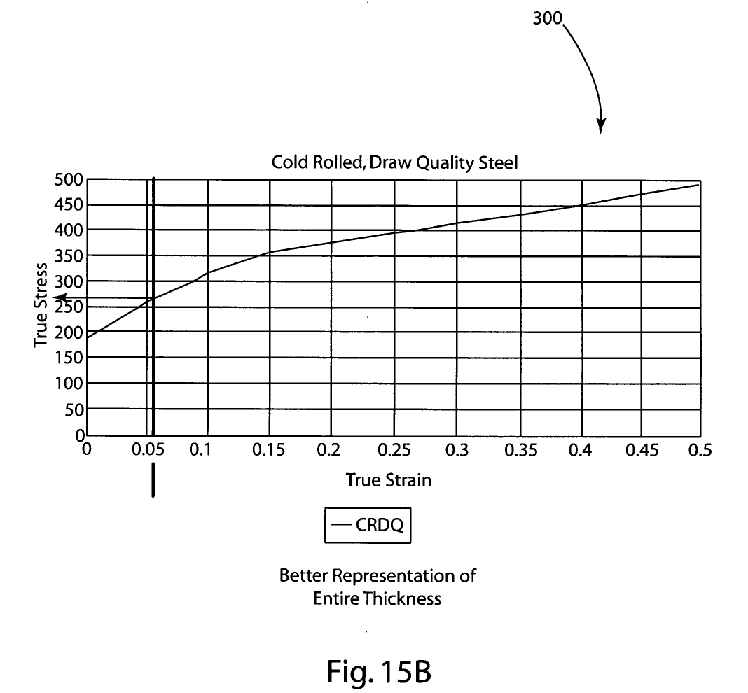

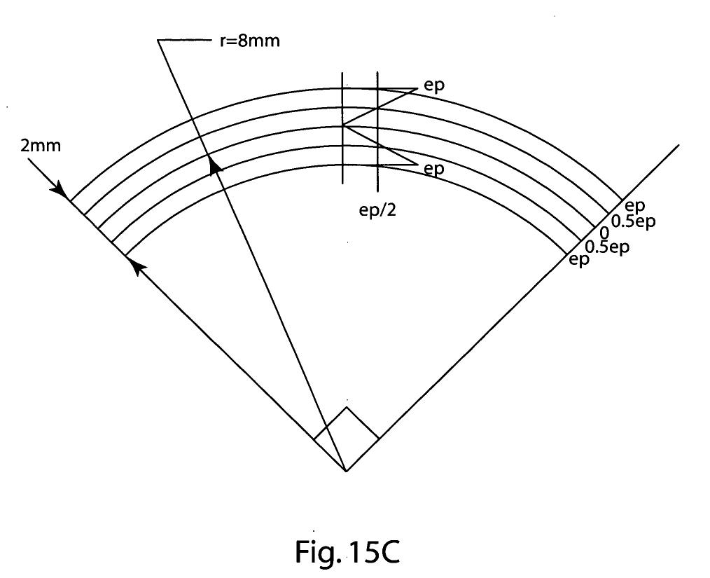

The foregoing description has been directed to general theories associated with strain estimation in accordance with the invention. Reference will now be made to general concepts associated with a potential manual application of the strain estimation method. More specifically, this method would be relatively tedious, although physically realizable. In greater detail, material properties could be modified in the bend area of parts, by essentially “shifting” the stress-strain curve by what could be characterized as the “estimated plastic strain”. The concepts of plastic strain and plasticity were previously described herein. These concepts are illustrated in the graph 300 shown in FIG. 15. The graph line represents the comparative relationship between stress and strain, for what is characterized as “as rolled” CRDQ steel. The term “CRDQ” refers to “Cold-Rolled-Draw-Quality” type of steel. This is the most typical type of steel utilized for stamping automotive parts. This steel meets the commonly known specification referred to as SAE J2329 grade 2.

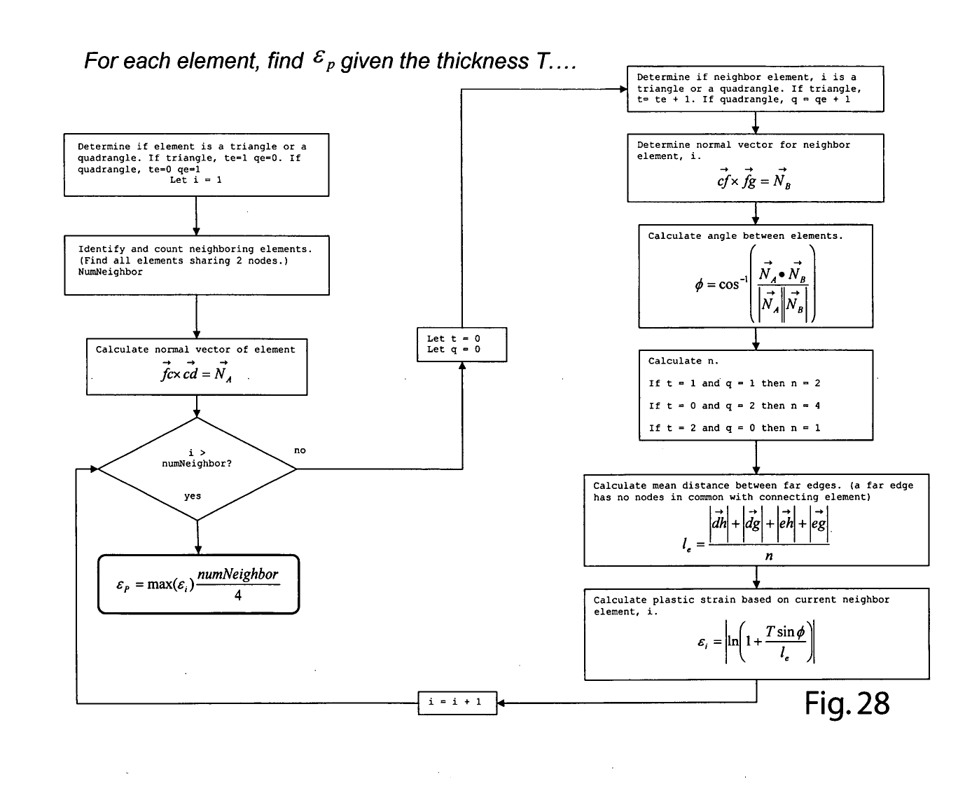

FIG. 28 comprises a sequence diagram which describes the process by which forming strains are estimated. Once estimated, these strains can be written in a format suitable for an FEA program (such as LS-DYNA) to read. Software programs like LS-DYNA will offset (i.e. increase) the original, as rolled material yield stress value of each element and at each through-thickness integration point, so as to automatically correspond with the estimated forming strain. Alternatively, this increase in yield strength could be defined by manually entering separate material properties for each element. The true-stress-true-effective-plastic-strain curve would then be shifted by the estimated forming strain of each element.

As an example, the bend area of a simple part could be given a new material definition, based on the estimated strain resulting from bending. A strip of steel having a thickness of 2 millimeters, and bent at a 90 degree angle about an 8 millimeter radius would have an outer fiber engineering strain of:

$$e = \frac{t}{2 r} = 0.125 \qquad Equation 7$$

A corresponding outer fiber true strain can then be defined as follows:
ε=1n(1+e)=0.118 Equation 8

Given the foregoing, FIG. 15 can now be characterized as illustrating the shifting of the true-stress-true-effective-plastic-strain curve of a typical type of automotive stamping steel that has undergone this type of strain during forming. In FIG. 15, the vertical line represents the “new material zero-strain” position, while the horizontal line represents the new material yield strength. Although this new material definition will accurately represent the material behavior of the outer fibers, it will somewhat “overestimate” the strength of the inner fibers, since these fibers will not experience the same amount of forming strain. To better represent the material behavior throughout the thickness of the steel, it may be preferable to define and materially represent the average bending (i.e. forming) strain throughout the thickness. Such a representation is illustrated in FIG. 15B. In the representation of FIG. 15B, the average bending strain throughout the thickness is approximately one half of the outer fiber strain.

Manually defining new materials, based on estimated forming strain is tedious and relatively less accurate, because one value of yield strength is used throughout the thickness. In the subsequent paragraphs herein, an automated method will be described, in accordance with the invention. This method provides strain estimates in accordance with the procedures illustrated in FIG. 28, at specific through-thickness locations (i.e. integration points) for each element. FIG. 15C shows integration points throughout the thickness, where strain estimates can be provided. FEA solvers will typically allow any number of integration points to be defined, and such solvers will also provide for interpolation between the integration points. In FIG. 15C, as an example, five integration points are illustrated.

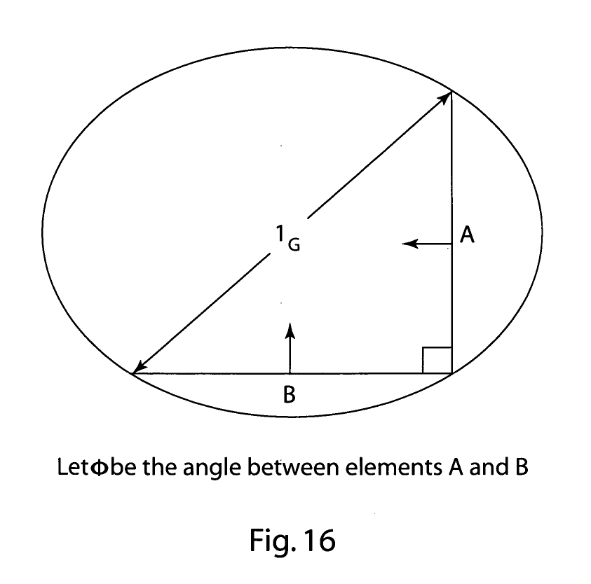

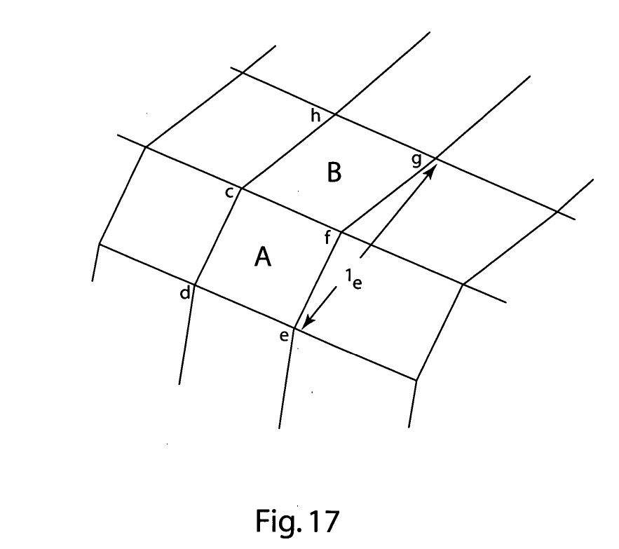

For purposes of adapting the formula t/2r to what could be characterized as shell elements, a formula was necessary for use in terms of the angle between two neighboring elements, and their lengths. For purposes of description, a “shell element” can be characterized as a triangular or quadrangular plate element having three or four corners (i.e. nodes), respectively. These nodes have locations in three dimensional coordinate space (i.e. Cartesian coordinate space). In this regard, the inventor noted the general observations illustrated by the drawing of FIG. 16. FIG. 16 illustrates two segments of a circle, namely segments A and B. Φ is characterized as the angle between the segments A and B, and length lₑ is characterized as the mean distance between far element edges. With these characterizations, the following observation can be made:

$$\frac{sin ϕ}{{l}_{e}} = \frac{1}{2 r} \qquad Equation 9$$

A still further observation, with reference to the thickness of the element as being thickness t, is shown as follows:

$$\frac{t sin ϕ}{{l}_{e}} = \frac{t}{2 r} = \vert {e}_{p} \vert \qquad Equation 10$$

where eₚ is the outer fiber plastic strain from forming a given element. With these observations, a conclusion can be made that the outer fiber strain eₚ from forming in a given element can be estimated using the following:
1. The angle Φ, between its normal vector and those of its neighboring elements;
2. The thickness t of the element; and
3. The mean distance between far element edges (namely, lₑ).

Given the observations and conclusions described in the foregoing paragraphs, related to estimation of plastic strain, the algorithm will now be described for the estimation of residual plastic strains from the forming process. First, the input file from the FEA software (such as LS-DYNA) can be parsed. The processing method for the estimation will be described herein with respect to FIG. 17. The quadrangular element “A” is the element for which the plastic strain is being estimated. A unique strain estimate is calculated for each neighbor of element A, and the estimate with the largest magnitude is used as the final estimate. FIG. 17 illustrates one of the neighbor elements labeled as element B. The lower case letters illustrated in FIG. 17 represent the nodes, which are locations in space. The mean distance between the far edges of the elements as represented by the dimension lₑ.

A function diagram of the method in accordance with the invention is shown in diagrammatic format in FIG. 28. An FEA model is parsed to obtain all the triangular and quadrangular plate elements along with the thickness and nodes that belong to them.

For each element starting with element A, a determination of thickness is made. As is typical for most FEA software, each element definition references a part identification number (PID). Each part definition references a section property identification number (SID). Each section definition contains the needed thickness information. The thickness value is stored in variable, T.

Next, element A is classified as either triangular or quadrangular. A triangular element can be identified as having just three nodes or, alternatively, four nodes where one of the nodes is a duplicate node identification number. The element classification values are stored in the variables te and qe. The iteration variable, i, is initialized with a value of one.

The next step involves finding all of the neighboring elements to element A. This is accomplished by counting and identifying all element identification numbers that reference two node identification numbers in common with element A. As shown in FIG. 17, the nodes c and f are common to element A and its neighbor element B. The number of neighbors found is stored in the variable NumNeighbor.

Since the angle between element A and each of its neighbors will have to be calculated, the normal vector of element A is next calculated. The cross product of the vector defined by nodes f and c and the vector defined by nodes c and d results in the normal vector of element A (the normal of the plane fcd). The normal vector is stored in the array \vec{N}_{A}.

The following step sequence is repeated for each neighbor element. The variables t and q are set to zero.

The neighbor element B is classified as either triangular or quadrangular. If the element is triangular, the variable t becomes te +1. If the element is quadrangular, the variable q becomes qe+1.

The normal vector of element B is calculated next. The cross product of the vector defined by nodes c and f, and the vector defined by nodes f and g, determine this vector. The normal vector is stored in the array \vec{N}_{B}.

The angle between elements A and B is calculated by taking the arc cosine of the fraction having a numerator of the normal vectors dot product and a denominator which is the product of normal vector magnitudes. Next, the variable n is determined based on the classification of elements A and B. If both are triangular, then n=1. If only one is triangular, then n=2. If both are quadrangular, then n=4.

The mean distance between far edges is next calculated by dividing the sum of node pair distances by n, the number of node pairs. Each distance between nodes is calculated by taking the square root of the sum of x, y and z axis differences squared. (Distance formula) The mean distance value is stored in the variable le.

As a final step for the current neighbor element B, the plastic strain is calculated.

$${ɛ}_{i} = \vert ln ( 1 + \frac{T sin ϕ}{{l}_{e}} ) \vert \qquad Equation 11$$

The maximum plastic strain estimate assigned to element A is calculated by taking the maximum of the plastic strains found for all neighbors of element A.

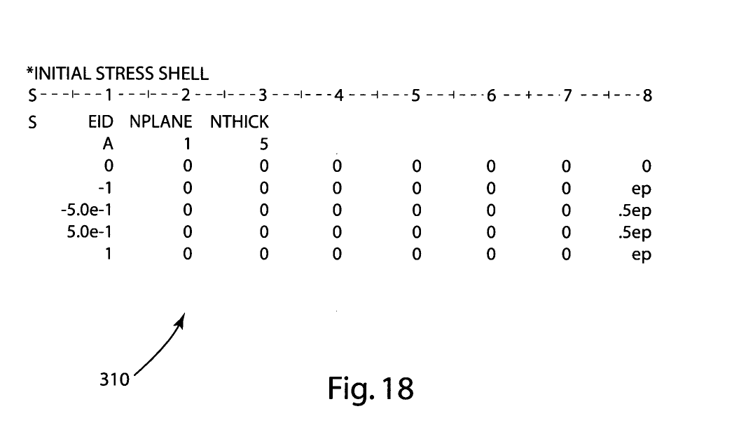

Following the functional steps described above, and with reference to the LS-DYNA software, the cards identified as the “INITIAL_STRESS_SHELL” cards are then written out. These cards are illustrated in FIG. 18. For the case when LS-DYNA finite element analysis software is used, estimated strains are written to a file in the format shown in FIG. 18. Rows 5-9 represent different thickness locations through the shell (plate) element. This location information is entered into the first column. Zero represents the middle of the thickness, −1 represents the bottom of the thickness, and +1 represents the top of the thickness. The thickness location coordinates +1 and −1 represent the outer fibers, and are therefore assigned the full plastic strain estimate, εₚ in column 8. The middle of the thickness is assigned no plastic strain, while the locations −0.5 and +0.5 are assigned one half of the estimated outer fiber strain. No initial stresses are defined in columns 2-7. Rows 2 and 3 are comments which are flagged to the software with a character “$.” Finally, the third row defines the element identification number for which the strains are to be applied, the number of in-plane integration points, and the number of through-thickness integration points.

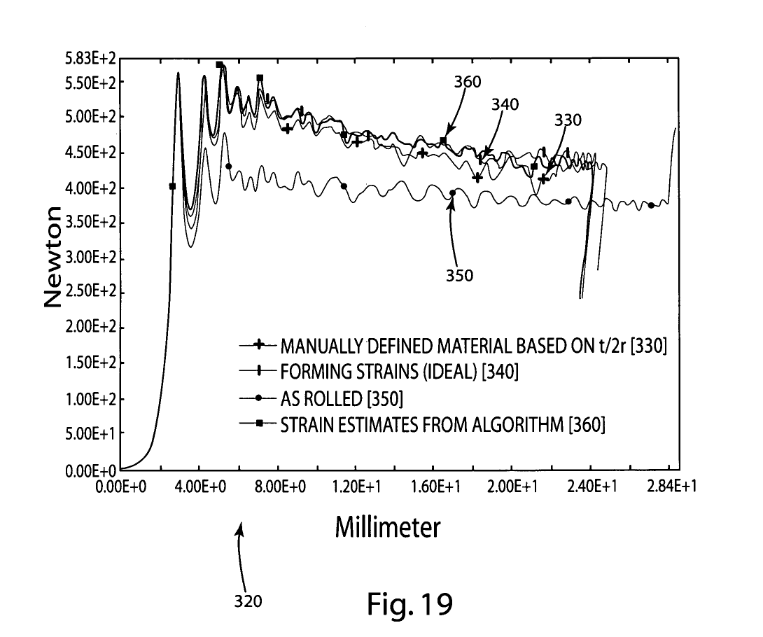

The foregoing has described a method in accordance with the invention for estimation of residual strains, resulting from forming of metal. Subsequent paragraphs herein will now describe a comparison of the results from simulations and estimations with respect to comparisons of force versus displacement curves for a specimen part comprising a simple bend. These comparison results are illustrated in graph 320 of FIG. 19. More specifically, graph 320 shows force versus displacement curves for four different LS-DYNA crash simulations. The curve 330 represents the force versus displacement curve obtained from the crash simulation when a new material is defined in the bend area, so as to account for forming effects. This new material was defined by shifting the “as rolled” stress-strain curve by the average bending strain. As earlier stated herein, the average bending strain through the thickness is one half of the estimated outer fiber strain of t/2r, where t is the part thickness and r is the radius of formed curvature.

Correspondingly, the curve 340 represents the force versus displacement curve obtained from the crash simulation, when actual forming strains obtained from the forming simulation are used. The curve 350 represents the force versus displacement curve obtained from the crash simulation when forming effects are ignored. Correspondingly, curve 360 represents the force versus displacement curve obtained from the crash simulation, when the strains from forming are estimated by the algorithm.

As apparent from graph 320 of FIG. 19, the force versus displacement curves obtained using the manual strain estimation method and the automated strain estimation method are relatively close to the results of the simulation which uses residual stresses and strains from the forming process. In addition to other concepts shown by graph 320, it is apparent that consideration of forming effects, even estimated effects, will clearly improve performance accuracy for a crash analysis.

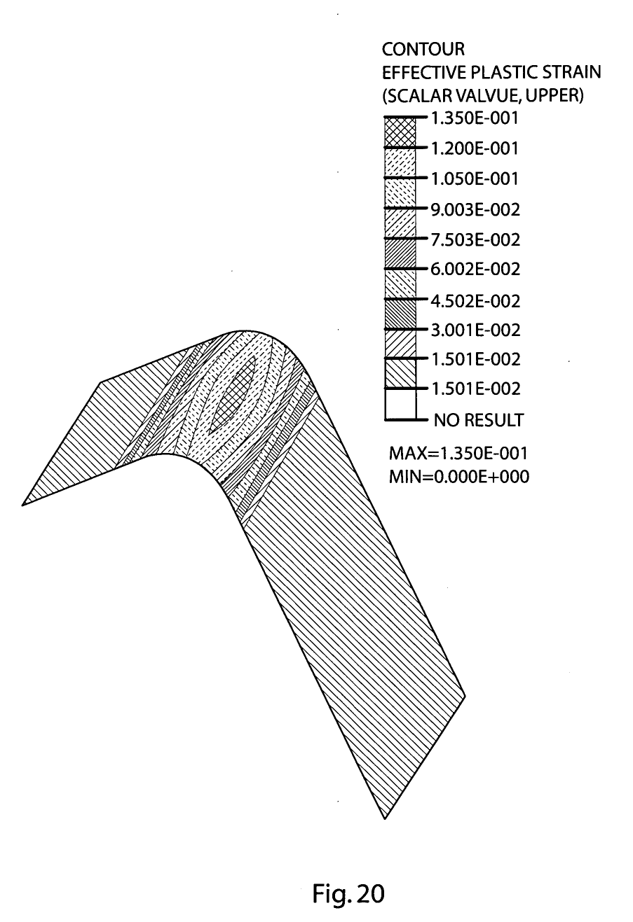

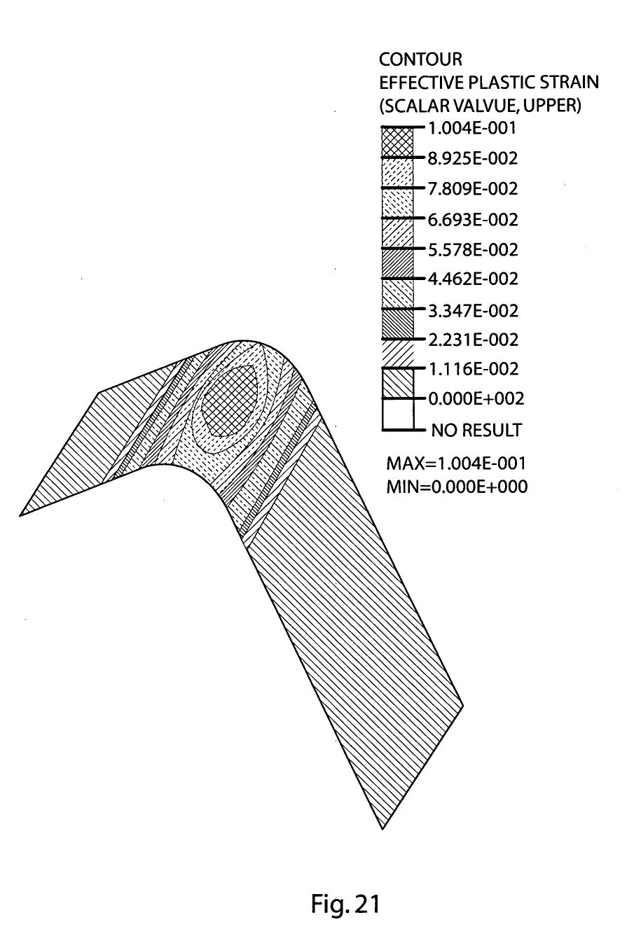

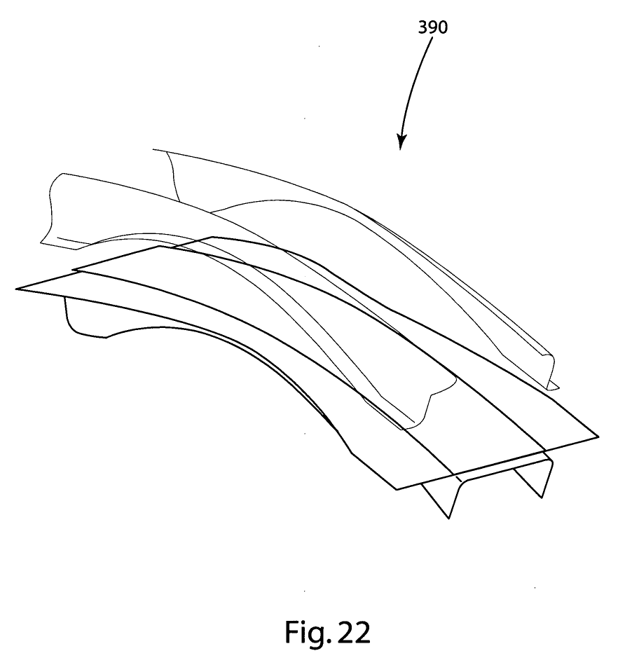

For purposes of additional background, FIG. 20 illustrates a crash model 370 corresponding to the single bend specimen part. More specifically, the crash model 370 represents the model resulting from the metal forming simulation process, showing effective plastic strains at the top fiber of the specimen part. Correspondingly, FIG. 21 illustrates a crash model 380 for the single specimen part, with the model corresponding to the component part on an “as rolled” basis, and illustrating the results from the process of estimation, for effective plastic strains at the top fiber of the specimen part.

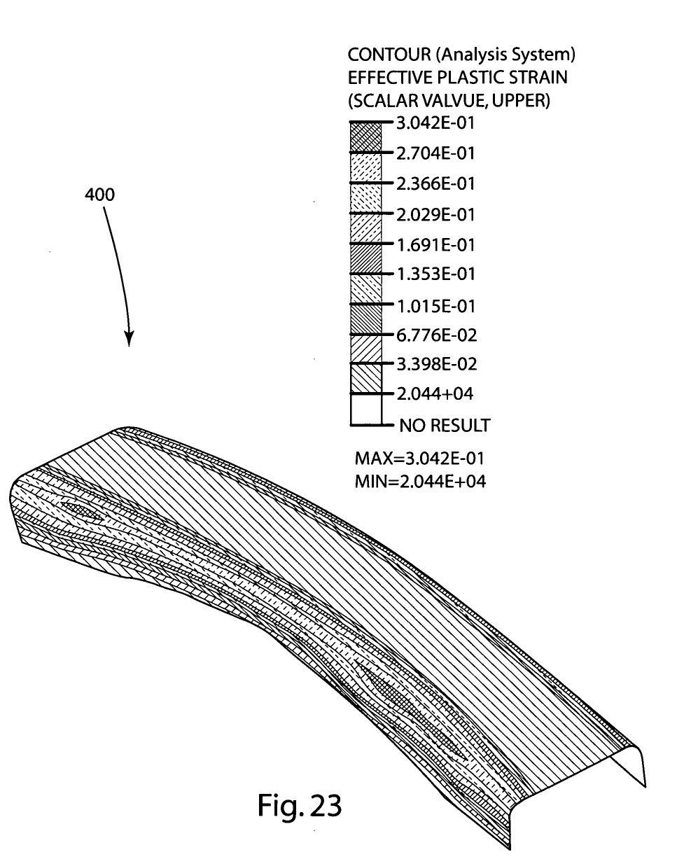

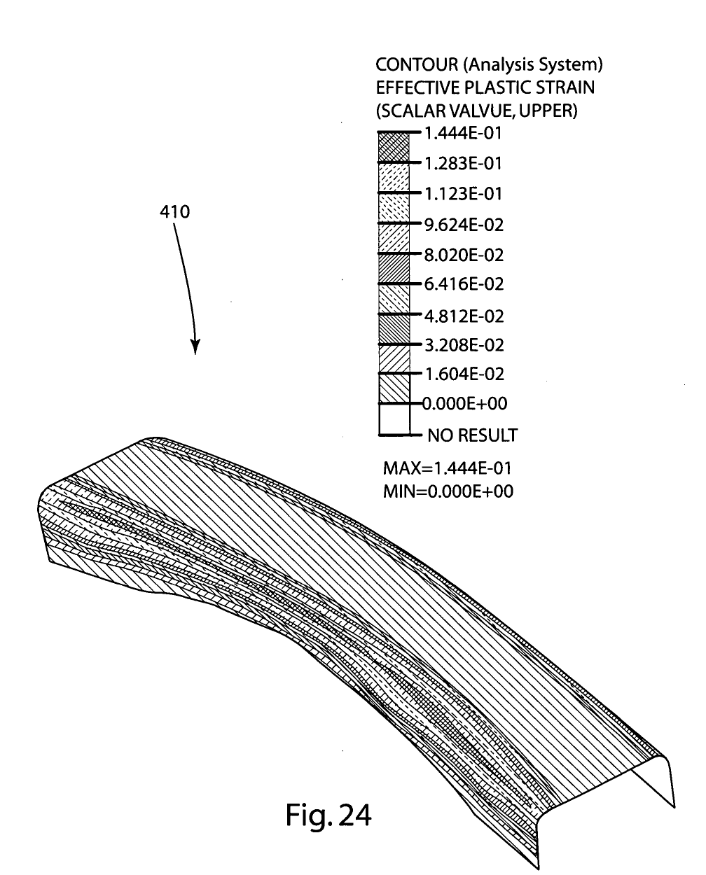

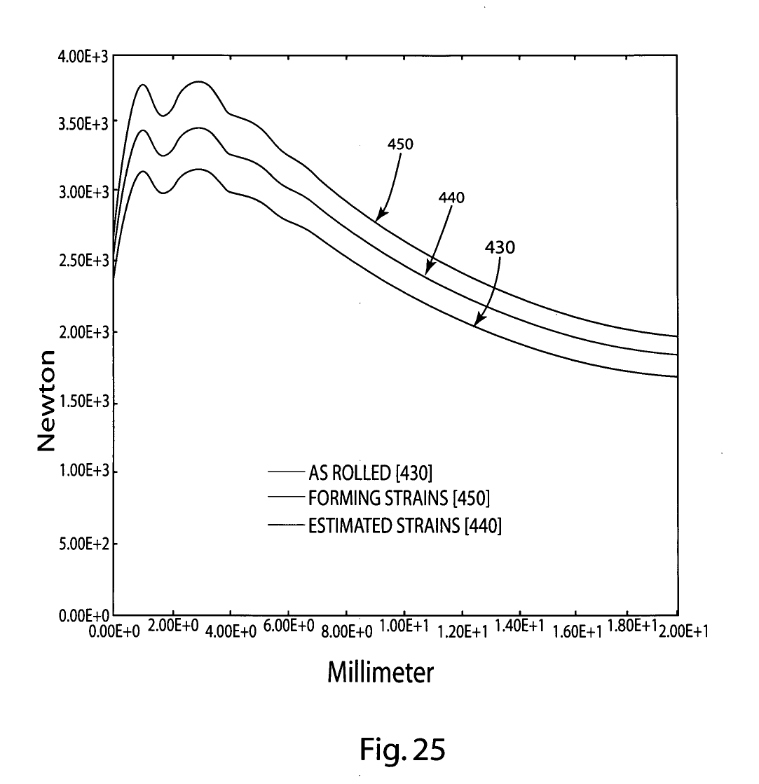

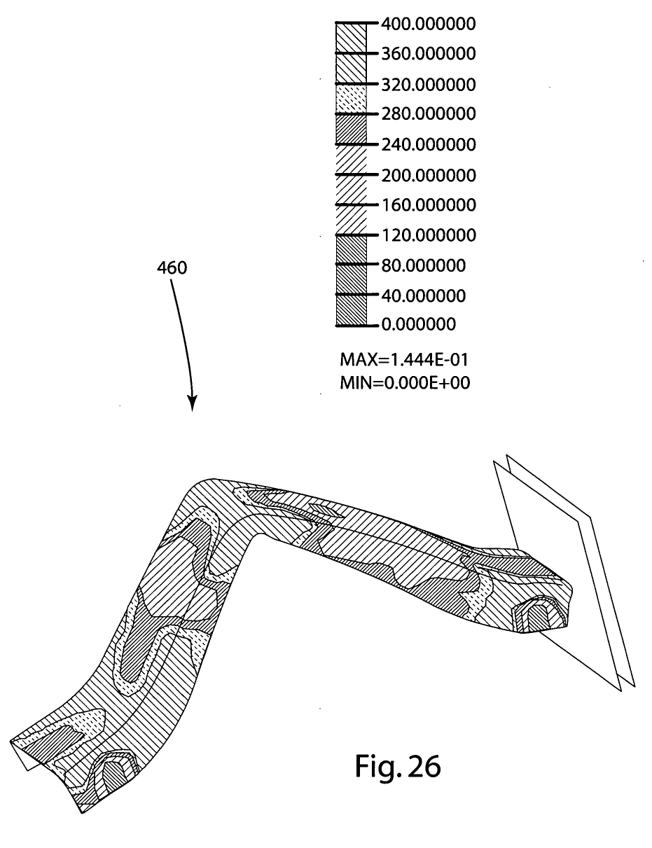

The foregoing paragraphs described simulation and estimation processes associated with a single bend specimen part. FIG. 22 illustrates a forming simulation model 390 for a steel bracket. The simulation essentially models the forming station of a progressive stamping die. For this simulation, it is assumed that a 0.5 inch strip of steel on each short end of the blank carries the steel bracket from one station in the die to the next consecutive station. For purposes of modeling this steel bracket strip, the process was undertaken with X and Y constraints used on one end of the blank, while the other end of the blank was assigned X constraints. In the forming station, a pad first comes down to press the blank into a “crown” shape. Thereafter, two blocks come down so as to wipe the flanges of the blank. In the simulation process, a dynain file is first written out, so as to be used as input for the springback simulation. Following completion of the springback simulation, a second dynain file is written out. The second file is written out for the purposes of initializing the stresses and strains for one of the crash simulations. For this steel bracket under analysis, FIG. 23 illustrates a model 400 using a forming simulation process, for determining the effective plastic strains at the top fiber of the specimen part. This is based on the “as rolled” configuration. FIG. 24 illustrates the component part as a model 410, corresponding to the effective plastic strains at the top fiber based on use of the estimation process, in accordance with the invention. FIG. 26 shows the entirety of the crash model 460 for the drawn part under test. Correspondingly, FIG. 25 illustrates a comparison of force versus displacement curves for the drawn part, using the various crash analysis processes for determining strains. More specifically, FIG. 25 illustrates the graph 420 showing force versus displacement. The line 430 represents force versus displacement for the component part on an “as rolled” basis. The line 450 on the graph 420 illustrates the force versus displacement curve for the effective strains utilizing the forming simulation process. Still further, the line 440 represents the force versus displacement curve determined through utilization of the estimation of strains in accordance with the processes set forth herein in accordance with the invention.

In accordance with all of the foregoing, a method has been described in accordance with the invention, which can be utilized to estimate residual strains from the forming of sheet metal, without the necessity of running forming simulations. These estimations of residual strains can be utilized to improve crash analysis of metal parts. As previously stated, for a first order crash analysis, the use of estimation of residual strains in accordance with the invention, instead of utilizing strains reported from several forming simulations, can increase the speed of a design process. As also described herein, methods in accordance with the invention estimate residual forming strains from the part's geometry itself, and assume that the part was formed from a planar sheet of metal.

With respect to crash analysis, the relative importance of considering the forming history of a part has been shown by the comparison of crash analysis results, with and without the consideration of residual strains. Further, the foregoing paragraphs describe physical test results, and compare the same for an as formed part, and an identical part which was heat treated, so as to relieve at least certain of the cold working strains. Following the analysis set forth herein, which indicated the importance of considering forming history, estimation methods in accordance with the invention for estimating residual strains were described.

Further with respect to estimation methods in accordance with the invention, these methods will normally apply to formed metal parts, where no significant change in material thickness occurs. Residual plastic strains from simple or compound bending are estimated, but strains resulting from “stretching” are not considered. It is believed that strains resulting from the stretching of formed parts would be underestimated by the estimation processes in accordance with the invention. Still further, it is believed that the estimation processes should likely not be utilized with meshes which can be considered of relatively poor quality. In any event, it is clear from the foregoing that the accuracy of crash analysis on initially-flat metal parts which contain bends and use as-rolled materials will improve by incorporating a determination of strains by estimation in accordance with the methods set forth herein under the invention.

It will be apparent to those skilled in the pertinent arts that other embodiments of methods in accordance with the invention can be implemented. That is, the principles of the invention are not limited to the specific embodiments described herein. Accordingly, it will be apparent to those skilled in the arts that modifications and other variations of the above-described illustrative embodiments of the invention may be effected without departing from the spirit and scope of the novel concepts of the invention.

1. A method for estimation and prediction of strains resulting from metal forming processes, said method comprising the steps of:
defining a geometric domain in which is represented the shape and configuration of a formed metal part;
discretizing said geometric domain into a plurality of elements representing said formed metal part;
for each element, determining a set of parameters indicative of physical characteristics and spatial characteristics of said each element;
estimating, for a first one of said elements, a maximum plastic strain resulting from said metal forming processes, as a function of said physical characteristics and said spatial characteristics of said first one of said elements and a subset of said elements, each of said subset of said elements being a neighboring element of said first one of said elements.

2. A method for estimation and prediction of strains in accordance with claim 1, characterized in that each of said elements comprises a plate element.

3. A method for estimation and prediction of strains in accordance with claim 2, characterized in that said discretizing of said geometric domain results in a mesh.

4. A method for estimation and prediction of strains in accordance with claim 2, characterized in that said plate elements comprise quadrilateral plate elements.

5. A method for estimation and prediction in accordance with claim 2, characterized in that said plate elements comprise triangular plate elements.

6. A method for estimation and prediction in accordance with claim 5, characterized in that said plate elements further comprise quadrilateral plate elements.

7. A method for estimation and prediction in accordance with claim 2, characterized in that said method further comprises the steps of:
estimating a plastic strain for each of said subset of elements; and
said step of estimating said maximum plastic strain of said first one of said elements is performed as a function of said estimates of plastic strains for each of said subset of said elements.

8. A method for estimation and prediction in accordance with claim 2, characterized in that said method further comprises the steps of:
estimating a plastic strain for each of said subset of elements; and
said step of estimating said maximum plastic strain of said first one of said elements includes a determination of a maximum of said estimates of plastic strains for each of said subset of said elements.

9. A method for estimation and prediction in accordance with claim 2, characterized in that said physical characteristics comprise thicknesses of each of said elements.

10. A method for estimation and prediction in accordance with claim 2, characterized in that said spatial characteristics comprise angles between a normal vector of said first one of said elements, and normal vectors of said subset of said elements.

11. A method for estimation and prediction in accordance with claim 2, characterized in that said method further comprises:
defining each of said elements as having edges; and
said spatial characteristics comprise mean distances between far element edges of said first one of said elements and each of said subset of said elements.

12. A method for estimation and prediction in accordance with claim 2, characterized in that said method further comprises a step of defining each of said elements as having nodes, each of said nodes having a specific location in three dimensional Cartesian coordinate space.

13. A method for estimation and prediction in accordance with claim 2, characterized in that the method further comprises, for each of said elements of said subset, performance of the following:
$${ɛ}_{i} = \vert ln ( 1 + \frac{T sin ϕ}{{l}_{e}} ) \vert$$
where εᵢ represents the calculated estimate of plastic strain for said element of said subset of the elements, T represents the thickness of said element of said subset, ø represents the angle between the normal vectors of said first one of said elements and said given subset element, and lₑ represents the mean distance between far element edges of said first one of said elements and said subset element.

14. A method for estimation and prediction in accordance with claim 13, characterized in that the maximum plastic strain estimate assigned to said first one of said elements is determined by taking the maximum of the estimated plastic strains found for all elements of said subset of said elements.
